(19) United States
(12) Patent Application Publication
(10) Pub. No.: US 2026/0216619 A1
(43) Pub. Date: Jul. 30, 2026

(54) METHODS OF SEPARATING LIGNIN DECONSTRUCTION FEEDSTOCKS USING CENTRIFUGAL PARTITION CHROMATOGRAPHY

(71) Applicant: Wisconsin Alumni Research Foundation, Madison, WI (US)

(72) Inventors: Shannon Stahl, Madison, WI (US); Surajudeen Omolabake, Madison, WI (US); Dillon Hofsommer, Madison, WI (US); Eric Weeda, Madison, WI (US); Christopher Holland, Madison, WI (US)

(73) Assignee: Wisconsin Alumni Research Foundation, Madison, WI (US)

(21) Appl. No.: 19/459,547

(22) Filed: Jan. 26, 2026

Related U.S. Application Data
(60) Provisional application No. 63/749,272, filed on Jan. 24, 2025.

(51) Int. Cl. B01D 15/18; C08H 7/00

(52) U.S. Cl. CPC B01D 15/1878; B01D 15/1885; B01D 15/1894; C08H 6/00

(57) ABSTRACT

Methods of separating components of lignin deconstruction feedstocks using centrifugal partition chromatography. The methods can be used for the binary separation of aromatic monomers from oligomers.

### STATEMENT REGARDING FEDERALLY SPONSORED RESEARCH

This invention was made with government support under DE-SC0018409 and DE-EE0011114 awarded by the US Department of Energy. The government has certain rights in the invention.

### FIELD OF THE INVENTION

The invention is directed to the use of centrifugal partition chromatography for separating various components of lignin deconstruction feedstocks, such as the binary separation of aromatic monomers from oligomers.

### BACKGROUND

Oxidative and other processes are used for the chemical modification and depolymerization of lignin, generally resulting in a heterogeneous mixture of aromatic monomers and higher molecular weight oligomers. Monomers are typically the preferred feedstock for downstream applications, such as chemical applications (e.g., for direct use in polymers), biological applications (e.g., biological funneling of aromatic monomers into platform chemicals), and other non-combustion applications. Thus, the aromatic monomers therefore typically need to be separated and isolated for further use.

Silica gel chromatography has been used to separate lignin monomers and oligomers, but results have been hampered by selectivity at scales >1 g. Preparative high pressure liquid chromatography (preparative HPLC) can be used to separate different aromatic monomer species. However, the technique is limited to the 0.5 g scale and often encounters clogging issues with repeated use of a column.

Scalable methods for separating components of depolymerized lignin, such as separating monomers from oligomers, are needed.

### SUMMARY OF THE INVENTION

Centrifugal partition chromatography (CPC) is a separation technique that utilizes liquid-liquid extraction to separate molecules. Despite the term “chromatography,” CPC does not employ a solid stationary phase but rather partitions components between two immiscible liquid phases. Either of the two phases may serve as the stationary phase in batch operation, with mixing occurring either in “ascending” or “descending” mode (FIG. 1 (A)). In batch operation, multiple individual components may be isolated, reflecting their differential partitioning in the two phases. In some versions of the present invention, CPC is employed in a scalable continuous process for binary separations by using a liquid-liquid variation of simulated moving bed (SMB) technology, pairing two liquid-liquid extraction rotors and alternating the flow direction of the two immiscible phases in a process referred to as true moving bed (TMB) CPC (FIG. 1 (B)).

The invention is directed to scalable methods for separating components of depolymerized lignin, such as separating monomers from oligomers, using various CPC formats.

One aspect of the invention is directed to methods of separating a first component and a second component of a lignin deconstruction composition.

In some versions, the methods comprise providing one or more samples. In some versions, the one or more samples comprises: a first sample comprising a first portion of the lignin deconstruction composition in a sample aliquot of a first phase of a multiple-phase solvent system; and/or a second sample comprising a second portion of the lignin deconstruction composition in a sample aliquot of a second phase of the multiple-phase solvent system.

In some versions, the methods comprise providing one or more centrifugal partition chromatography columns, each column comprising a plurality of fluidically connected cells and: a column aliquot of the first phase of the multiple-phase solvent system within the plurality of fluidically connected cells; and/or a column aliquot of the second phase of the multiple-phase solvent system within the plurality of fluidically connected cells.

In some versions, the methods comprise introducing at least one of the one or more samples into the one or more centrifugal partition chromatography columns.

In some versions, the methods comprise separating the first component from the second component within the one or more columns.

In some versions, the methods comprise collecting eluate from the one or more columns. In some versions, the eluate comprises: a first eluate comprising a proportion of the first component relative to the second component that is greater than a proportion of the first component relative to the second component in the lignin deconstruction composition; and/or a second eluate comprising a proportion of the second component relative to the first component that is greater than a proportion of the second component relative to the first component in the lignin deconstruction composition.

In some versions, the first component comprises, consists essentially of, or consists of one or more aromatic monomers. In some versions, the one or more aromatic monomers comprise, consist essentially of, or consist of any one or more, any two or more, any three or more, any four or more, any five or more, any six or more, any seven or more, any eight or more, any nine or more, or each of para-hydroxybenzaldehyde, para-hydroxybenzoic acid, vanillin, vanillic acid, acetovanillone, 5-formyl-2-hydroxy-3-methoxybenzoic acid, 5-carboxyvanillic acid, syringaldehyde, syringic acid, and acetosyringone.

In some versions, the second component comprises an aromatic oligomer.

In some versions, the lignin deconstruction composition comprises chemically depolymerized lignin. In some versions, the lignin deconstruction composition comprises oxidatively depolymerized lignin. In some versions, the lignin deconstruction composition comprises any one or more, any two or more, any three or more, any four or more, any five or more, any six or more, any seven or more, any eight or more, any nine or more, or each of para-hydroxybenzaldehyde, para-hydroxybenzoic acid, vanillin, vanillic acid, acetovanillone, 5-formyl-2-hydroxy-3-methoxybenzoic acid, 5-carboxyvanillic acid, syringaldehyde, syringic acid, and acetosyringone.

In some versions, the multiple-phase solvent system comprises, consists essentially of, or consists of alkane, ethyl acetate, methanol, and water. In some versions, the multiple-phase solvent system comprises: alkane in an amount of at least 10% and up to 23% v/v of the multiple-phase solvent system; ethyl acetate in an amount of at least 27% and up to 40% v/v of the multiple-phase solvent; methanol in an amount of at least 10% and up to 23% v/v of the multiple-phase solvent system; and water in an amount of at least 27% and up to 40% v/v of the multiple-phase solvent. In some versions, the multiple-phase solvent system comprises a first multiple-phase solvent system comprising: alkane in an amount of at least 10% and up to 14% v/v of the multiple-phase solvent system; ethyl acetate in an amount of at least 36% and up to 40% v/v of the multiple-phase solvent; methanol in an amount of at least 10% and up to 14% v/v of the multiple-phase solvent system; and water in an amount of at least 36% and up to 40% v/v of the multiple-phase solvent. In some versions, the multiple-phase solvent system comprises a second multiple-phase solvent system comprising: alkane in an amount of at least 17% and up to 23% v/v of the multiple-phase solvent system; ethyl acetate in an amount of at least 27% and up to 33% v/v of the multiple-phase solvent; methanol in an amount of at least 17% and up to 23% v/v of the multiple-phase solvent system; and water in an amount of at least 27% and up to 33% v/v of the multiple-phase solvent.

In some versions, the one or more columns each comprises the column aliquot of the first phase of the multiple-phase solvent system and the column aliquot of the second phase of the multiple-phase solvent system.

In some versions: the one or more columns comprises a first column of the one or more columns and a second column of the one or more columns, wherein the first column and the second column are connected via a fluidic junction therebetween, and the first column, the fluidic junction, and the second column form a continuous, linear, fluidically connected array of the fluidically connected cells; and the introducing comprises introducing at least one of the one or more samples into the one or more centrifugal partition chromatography columns via the fluidic junction.

In some versions, the introducing comprises introducing the first sample into the one or more centrifugal partition chromatography columns. In some versions, the introducing comprises introducing the second sample into the one or more centrifugal partition chromatography columns.

In some versions, the separating comprises: flowing a separation aliquot of the first phase of the multiple-phase solvent system through the one or more centrifugal partition chromatography columns and/or flowing a separation aliquot of the second phase of the multiple-phase solvent system through the one or more centrifugal partition chromatography columns.

In some versions, the separating comprises: flowing a separation aliquot of the first phase of the multiple-phase solvent system through the one or more centrifugal partition chromatography columns in an ascending mode and/or flowing a separation aliquot of the second phase of the multiple-phase solvent system through the one or more centrifugal partition chromatography columns in a descending mode.

In some versions, the methods comprise: simultaneously flowing a separation aliquot of the first phase of the multiple-phase solvent system through the one or more centrifugal partition chromatography columns and collecting the first eluate; and/or simultaneously flowing a separation aliquot of the second phase of the multiple-phase solvent system through the one or more centrifugal partition chromatography columns and collecting the second eluate.

In some versions, the methods comprise: simultaneously flowing a separation aliquot of the first phase of the multiple-phase solvent system through the one or more centrifugal partition chromatography columns in an ascending mode and collecting the first eluate; and/or simultaneously flowing a separation aliquot of the second phase of the multiple-phase solvent system through the one or more centrifugal partition chromatography columns in a descending mode and collecting the second eluate.

In some versions, the methods comprise: simultaneously introducing the first sample into the one or more centrifugal partition chromatography columns, flowing a separation aliquot of the first phase of the multiple-phase solvent system through the one or more centrifugal partition chromatography columns in an ascending mode, and collecting the first eluate; and/or simultaneously introducing the second sample into the one or more centrifugal partition chromatography columns, flowing a separation aliquot of the first phase of the multiple-phase solvent system through the one or more centrifugal partition chromatography columns in an ascending mode, and collecting the first eluate.

In some versions, the first phase of the multiple-phase solvent system is an upper phase of the multiple-phase solvent system, and the second phase of the multiple-phase solvent system is a lower phase of the multiple-phase solvent system.

In some versions: the multiple-phase solvent system is the first multiple phase solvent system; the first phase is an upper phase of the first multiple phase solvent system; the second phase is a lower phase of the first multiple phase solvent system; the separating and collecting each comprises flowing a separation aliquot of the first phase of the multiple-phase solvent system through the one or more centrifugal partition chromatography columns in an ascending mode and flowing a separation aliquot of the second phase of the multiple-phase solvent system through the one or more centrifugal partition chromatography columns in a descending mode; the first component comprises, consists essentially of, or consists of any one or more, any two or more, any three or more, any four or more, any five or more, any six or more, any seven or more, any eight or more, any nine or more, or each of para-hydroxybenzaldehyde, para-hydroxybenzoic acid, vanillin, vanillic acid, acetovanillone, 5-formyl-2-hydroxy-3-methoxybenzoic acid, 5-carboxyvanillic acid, syringaldehyde, syringic acid, and acetosyringone; and the second component comprises an aromatic oligomer.

In some versions: the multiple-phase solvent system is the second multiple phase solvent system; the first phase is an upper phase of the first multiple phase solvent system; the second phase is a lower phase of the first multiple phase solvent system; the separating comprises flowing a separation aliquot of the first phase of the multiple-phase solvent system through the one or more centrifugal partition chromatography columns in an ascending mode and flowing a separation aliquot of the second phase of the multiple-phase solvent system through the one or more centrifugal partition chromatography columns in a descending mode; the collecting the first eluate comprises flowing a separation aliquot of the first phase of the multiple-phase solvent system through the one or more centrifugal partition chromatography columns in a descending mode; the first component comprises, consists essentially of, or consists of any one or more, any two or more, any three or more, any four or more, any five or more, any six or more, any seven or more, or each of para-hydroxybenzaldehyde, para-hydroxybenzoic acid, vanillin, vanillic acid, acetovanillone, 5-formyl-2-hydroxy-3-methoxybenzoic acid, syringaldehyde, and acetosyringone; and the collecting the second eluate comprises flowing a separation aliquot of the first phase of the multiple-phase solvent system through the one or more centrifugal partition chromatography columns in an ascending mode and flowing a separation aliquot of the second phase of the multiple-phase solvent system through the one or more centrifugal partition chromatography columns in a descending mode; and the second component comprises an aromatic oligomer.

The objects and advantages of the invention will appear more fully from the following detailed description of the preferred embodiment of the invention made in conjunction with the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1. Centrifugal partition chromatography (CPC). A. CPC with alternating flow of the heavy phase in descending mode or light phase in ascending mode. B. Continuous separation of aromatic monomers and oligomers obtained from lignin depolymerization using dual-rotor liquid-liquid extraction (LLE).

FIG. 2. Elements of a CPC column, including a rotor (A), disks of the rotor (B), and channel-linked cells within the disks (C).

FIGS. 3A and 3B. Principle of CPC, including partitioning of molecules between mobile and stationary phases according to K_{d} (FIG. 3A) and movement of the molecules and the mobile phase through the CPC column (FIG. 3B).

FIG. 4. A schema of true moving bed (TMB) CPC.

FIG. 5. Exemplary process from lignin to separated products using lignin depolymerization and compound separation using centrifugal partition chromatography (CPC).

FIG. 6. Exemplary deconstruction of lignin to aromatic monomers, dimers, trimers and oligomers in a continuous flow reactor (as described in, e.g., US 2025/0002520 A1 and WO 2023/244264).

FIGS. 7A-7C. Batch CPC traces of Arizona H, J, K and L systems after separation of lignin depolymerization mixture. FIG. 7A. CPC chromatogram for Arizona H and K in ascending modes. FIG. 7B. CPC chromatogram for Arizona H and J in descending modes. FIG. 7C. CPC chromatogram for Arizona K and L in descending modes.

FIG. 8. Diagram and CPC chromatogram for an example of stacked injection.

FIG. 9. Trapping mode separation using Arizona L solvent system. A. Diagram of the oligomer removal/monomer trapping sequence. B. Diagram showing monomer extrusion. C. CPC Chromatogram for cycles 1-5 of oligomer removal/trapping sequence. D. CPC trace of monomer collection during extrusion.

### DETAILED DESCRIPTION OF THE INVENTION

Centrifugal partition chromatography (CPC) is a liquid-liquid purification technique that does not require traditional solid supports used in classical liquid chromatography techniques, such as HPLC. CPC can isolate the maximum amount of a specific molecule or molecules at the highest purity in a minimum of time and without using any silica column or support media. CPC has some similarities to classical liquid chromatography techniques insofar as they use the same fundamental chromatographic process as well as the same instrument peripherals (pumps, injectors, inline detectors and fraction collectors). The fundamental difference between classical liquid chromatography on solid supports and CPC is the nature of the stationary phase. The stationary phase in classical liquid chromatography is typically made of particles of coated or non-coated silica. The skeleton of the particles are typically only a support and the surface chemistry generates chemical interactions with the mobile phase and compounds to be separated. CPC does not require a solid support like silica. Instead, two immiscible liquid phases are used. One serves as the mobile phase or the eluent, and the other as the stationary phase. The stationary phase is retained in the column by a centrifugal field. The affinity of the solute for each phase can be measured by their distribution ratio (K_{d}) that in turn dictates the order of elution for each compound.

Classical liquid chromatography columns are simply made: a cylinder (stainless steel in HPLC and plastic or glass in Flash Chromatography) with an inlet and outlet at each end, filled with a solid stationary phase, usually silica. The CPC column also has an inlet and outlet for the mobile phase. However, to be able to maintain one phase of the biphasic system inside the column, a centrifugal field and specially designed CPC disks are used.

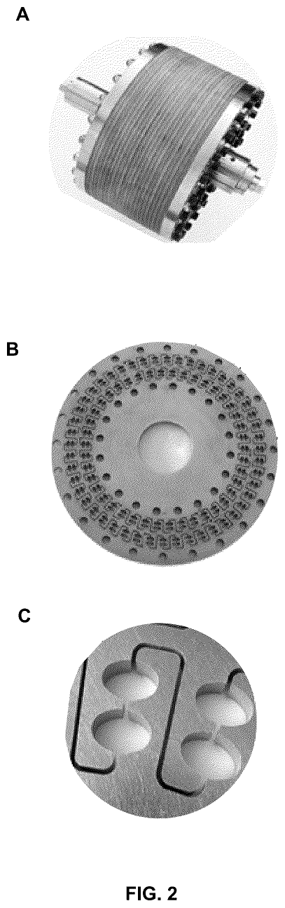

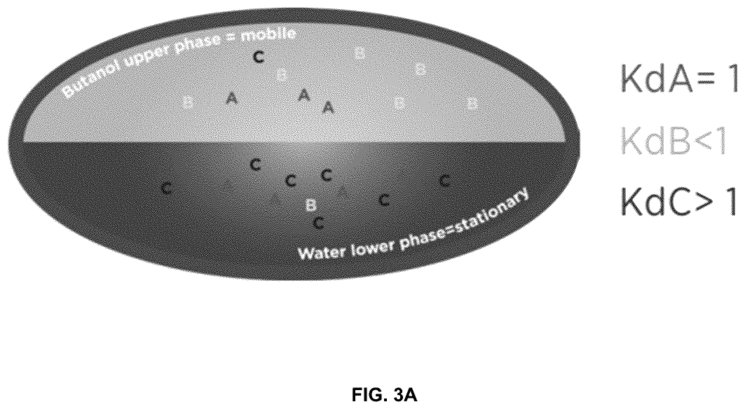

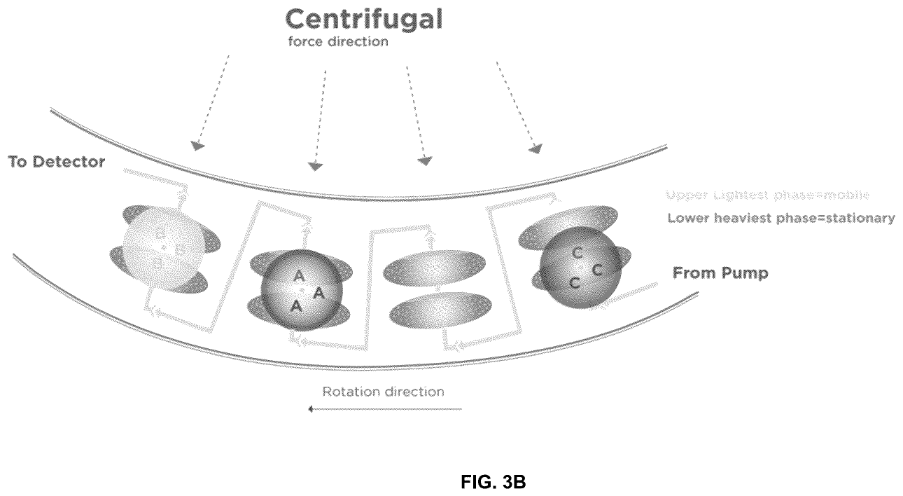

The CPC column includes of a number of CPC disks (FIG. 2 (B)) arranged on a rotor (FIG. 2 (A)). The rotor starts to spin to create the centrifugal force that retains the stationary phase. The disks include a number of cells linked together by a thin channel (FIG. 2 (C)). A CPC column can include over a thousand cells with a rotary seal at each end to connect the spinning column to the pumping system, detector, and other system components. A valve can allow for a change in the direction of flow and therefore the CPC system will work in either ascending mode (FIG. 3B) or in descending mode. This allows both normal and reverse modes without replacing the column.

The chromatographic effect in CPC relies on the experimentally determined distribution ratio K_{d} (or computationally calculated partition coefficient, Kₚ). This is the equilibrium constant for the distribution of an analyte in two immiscible solvents. For a particular compound, the Kais equal to the ratio of its molar concentration in the stationary phase to its molar concentration in the mobile phase as per the equation K_{d}=[a]stationary phase/[a]mobile phase (FIG. 3A). A K_{d} of 1 represents equal distribution between the mobile and stationary phase. To effect a CPC separation the analyte of interest should be between K_{d} 0.5-5. If the K_{d} is too low (e.g., below 0.5), the analyte is retained in the mobile phase and no separation occurs. If too high (e.g., over 5) the analyte is retained in the stationary phase. The solvent system can then be determined according to the distribution ratio of all molecules that need to be separated.

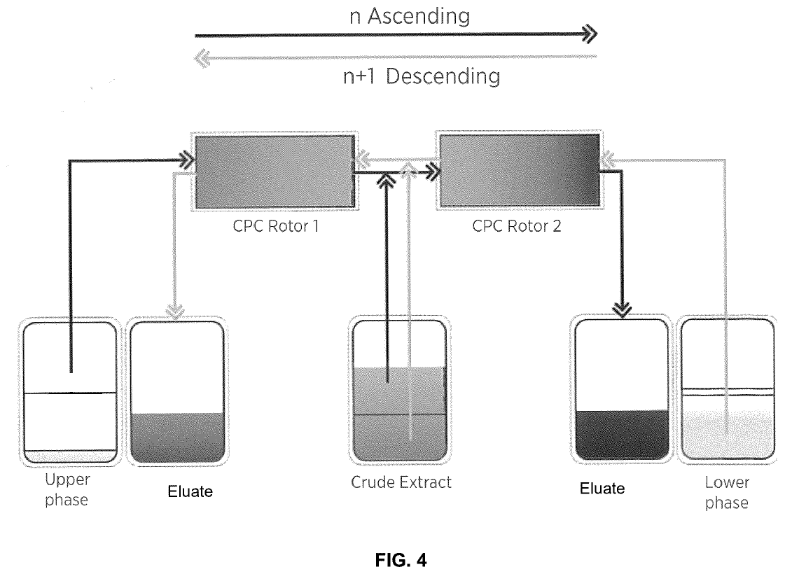

In addition to “batch” CPC systems, continuous CPC systems exist that use a true moving bed (TMB) concept (FIG. 4). Batch CPC is similar to HPLC in that injection occurs at the head of the column and separated compounds are eluted at the end. True moving bed systems include two CPC columns with two pumping systems. The sample is injected continuously at the junction of both columns, and separation is effected by an alternating sequence of steps where the mobile phase is alternatively the upper phase and the lower phase. For a simple binary mixture, the molecule that has more affinity for the lower phase will be eluted to the one end of the system, and the molecule that has more affinity for the upper phase will be eluted to the other end. FIG. 4 illustrates a continuous separation of two dyes. The green mixture is continuously injected between both columns. Pure red dye is recovered at the right outlet of the system, and pure blue is recovered at the left outlet.

One aspect of the invention is directed to the use of CPC and other similar methods for separating various components from lignin deconstruction compositions.

Some embodiments of the invention comprise methods of separating various components of a lignin deconstruction composition. “Lignin deconstruction composition” refers to a composition comprising components obtained from the deconstruction (e.g., breakdown, depolymerization) of lignin or derivatives thereof.

The lignin deconstruction composition can be obtained using any lignin deconstruction method. Examples include chemical depolymerization, electrochemical depolymerization, microbial depolymerization, and other methods. See, e.g., WO 2023/244264 A2, US 2024/0368777 A1, US 2022/0127217 A1, U.S. Pat. No. 8,969,534 B2, U.S. Pat. No. 11,028,235 B2, U.S. Pat. No. 9,359,391 B2, Pandey et al. 2010 (Pandey M P, Kim C S. Lignin Depolymerization and Conversion: A Review of Thermochemical Methods. Chemical & Engineering Technology, 2010, Vol. 34, Issue 1, pp. 3-145), and Wang et al. 2013 (Wang H, Tucker M, Ji Y. Recent Development in Chemical Depolymerization of Lignin: A Review. Journal of Applied Chemistry, 2013, Volume 2013, Article ID 838645). The methods of deconstructing lignin can comprise pretreating lignocellulosic biomass. Methods of pretreating lignocellulosic biomass are well known in the art. See Kumar et al. 2017 (Kumar AK and Sharma S. Recent Updates on Different Methods of Pretreatment of Lignocellulosic Feedstocks: A Review. Bioresour. Bioprocess. (2017) 4:7); Kumar et al. 2009 (Kumar, P.; Barrett, D. M.; Delwiche, M. J.; Stroeve, P., Methods for Pretreatment of lignocellulosic Biomass for Efficient Hydrolysis and Biofuel Production. Industrial & Engineering Chemistry Research 2009, 48, (8), 3713-3729); Wang et al. 2013 (Wang H, Tucker M, Ji Y. Recent Development in Chemical Depolymerization of Lignin: A Review. (2013) Journal of Applied Chemistry. 2013:1-9), and Karlen et al. 2020 (Karlen S D, Fasahati P, Mazaheri M, Serate J, Smith R A, Sirobhushanam S, Chen M, Tymkhin V I, Cass C L, Liu S, Padmakshan D, Xie D, Zhang Y, McGee M A, Russell J D, Coon J J, Kaeppler H F, de Leon N, Maravelias C T, Runge T M, Kaeppler S M, Sedbrook J C, Ralph J. Assessing the viability of recovering hydroxycinnamic acids from lignocellulosic biorefinery alkaline pretreatment waste streams. ChemSusChem. 2020 Jan. 26). Examples of pretreatment include chipping, grinding, milling, steam pretreatment, ammonia fiber expansion (AFEX, also referred to as ammonia fiber explosion), ammonia recycle percolation (ARP), CO2 explosion, steam explosion, ozonolysis, wet oxidation, acid hydrolysis, dilute-acid hydrolysis, alkaline hydrolysis, organosolv, ionic liquids, gamma-valerolactone, and pulsed electrical field treatment, among others. The lignin can be derived from any source, such as corn cobs, corn stover, cotton seed hairs, grasses, hardwood stems, leaves, newspaper, nut shells, paper, softwood stems, sorghum, switchgrass, waste papers from chemical pulps, wheat straw, wood, woody residues, mixed biomass species such as those produced by native prairie, black liquor, and other sources.

Accordingly, in some embodiments, the lignin deconstruction composition comprises chemically depolymerized lignin. “Chemically depolymerized lignin” refers to a lignin deconstruction composition comprising one or more components generated from chemically depolymerizing lignin. In some embodiments, the lignin deconstruction composition comprises oxidatively depolymerized lignin. “Oxidatively depolymerized lignin” refers to a lignin deconstruction composition comprising one or more components generated from oxidatively depolymerizing lignin. Methods of oxidatively depolymerizing lignin are well known in the art. See, e.g., US 2025/0002520 A1, WO 2023/244264 A2, US 2022/0127217 A1, and U.S. Pat. No. 8,969,534 B2.

In some embodiments, the lignin deconstruction composition comprises one or more aromatic monomers and one or more aromatic oligomers. “Aromatic monomer” as used herein with reference to a lignin deconstruction component refers to a lignin deconstruction component containing one and only one C6 aromatic ring. “Aromatic oligomer” as used herein with reference to a lignin deconstruction component refers to a lignin deconstruction component containing more than one C6 aromatic ring, such as 2, 3, 4, 5, 6, 7, 8, 9, 10, 11, 12, 13, 14, 15, 16, 17, 18, 19, 20, 25, 30, or more C6 aromatic rings. In any given embodiment herein, a given aromatic oligomer or group of aromatic oligomers may have fewer than 30, fewer than 25, fewer than 20, fewer than 19, fewer than 18, fewer than 17, fewer than 16, fewer than 15, fewer than 14, fewer than 13, fewer than 12, fewer than 11, or fewer than 10 C6 aromatic rings. A large number of aromatic monomers and aromatic oligomers derived from lignin deconstruction are known in the art. See, e.g., WO 2023/244264 A2, U.S. Pat. No. 8,969,534 B2, US 2024/0368777 A1, US 2022/0127217 A1, U.S. Pat. No. 11,028,235 B2, U.S. Pat. No. 9,359,391 B2, U.S. Pat. No. 11,985,974 B2, U.S. Pat. No. 11,981,904 B2, U.S. Pat. No. 11,807,875 B2, U.S. Pat. No. 11,807,876 B2, U.S. Pat. No. 11,447,754 B2, U.S. Pat. No. 11,414,372 B2, U.S. Pat. No. 10,883,089 B2, U.S. Pat. No. 10,883,090 B2, U.S. Pat. No. 10,829,745 B2 U.S. Pat. No. 10,227,287 B2, U.S. Pat. No. 9,388,285 B2, U.S. Pat. No. 8,685,672 B2, U.S. Pat. No. 8,569,465 B2, U.S. Pat. No. 11,981,946 B2, U.S. Pat. No. 11,447,754 B2, U.S. Pat. No. 11,242,544 B2, U.S. Pat. No. 11,028,418 B2, U.S. Pat. No. 11,008,577 B1, U.S. Pat. No. 10,829,745 B2, U.S. Pat. No. 10,273,511 B2, and U.S. Pat. No. 10,144,938 B2.

In some embodiments, the lignin deconstruction composition comprises any one or more, any two or more, any three or more, any four or more, any five or more, any six or more, any seven or more, any eight or more, any nine or more, or each of para-hydroxybenzaldehyde, para-hydroxybenzoic acid, vanillin, vanillic acid, acetovanillone, 5-formyl-2-hydroxy-3-methoxybenzoic acid, 5-carboxyvanillic acid, syringaldehyde, syringic acid, and acetosyringone. In some embodiments, the lignin deconstruction composition comprises any one or more, any two or more, any three or more, any four or more, any five or more, any six or more, any seven or more, any eight or more, any nine or more, or each of para-hydroxybenzaldehyde, para-hydroxybenzoic acid, vanillin, vanillic acid, acetovanillone, 5-formyl-2-hydroxy-3-methoxybenzoic acid, 5-carboxyvanillic acid, syringaldehyde, syringic acid, and acetosyringone and a least one aromatic oligomer.

The methods of the invention preferably employ a multiple-phase solvent system. “Multiple-phase solvent system” refers to a mixture of solvents that separates into multiple distinct liquid phases when combined. Multiple-phase solvent systems include two-phase solvent systems, in which the mixture separates into two phases, and three-phase solvent systems, in which the mixture separates into three phases. Exemplary multiple-phase solvent systems include the “Arizona” solvent systems (Foucault, A. P.; Chevolot, L. Counter-Current Chromatography: Instrumentation, Solvent Selection and Some Recent Applications to Natural Product Purification. J. Chromatogr. A 1998, 808, 3-22) (Table 1).

TABLE 1
Exemplary Arizona solvent systems.

| Initial Parts (v/v/v/v) | | | | | Initial % v/v | | | | Upper/ | |
|---|---|---|---|---|---|---|---|---|---|---|
| | | Ethyl | | | Volume | Ethyl | | | lower | Settling |
| Letter | Alkane* | acetate | MeOH | H₂O | Alkane* | acetate | MeOH | H₂O | phase ratio | time (s) |
| A | 0 | 1 | 0 | 1 | 0.0 | 50.0 | 0.0 | 50.0 | 0.88 | 36 |
| B | 1 | 19 | 1 | 19 | 2.5 | 47.5 | 2.5 | 47.5 | 0.92 | 31 |
| C | 1 | 9 | 1 | 9 | 5.0 | 45.0 | 5.0 | 45.0 | 0.965 | 28 |
| D | 1 | 6 | 1 | 6 | 7.1 | 42.9 | 7.1 | 42.9 | 0.96 | 29 |
| F | 1 | 5 | 1 | 5 | 8.3 | 41.7 | 8.3 | 41.7 | 0.95 | 30 |
| G | 1 | 4 | 1 | 4 | 10.0 | 40.0 | 10.0 | 40.0 | 0.95 | 25 |
| H | 1 | 3 | 1 | 3 | 12.5 | 37.5 | 12.5 | 37.5 | 0.945 | 25 |
| J | 2 | 5 | 2 | 5 | 14.3 | 35.7 | 14.3 | 35.7 | 0.91 | 20 |
| K | 1 | 2 | 1 | 2 | 16.7 | 33.3 | 16.7 | 33.3 | 0.88 | 21 |
| L | 2 | 3 | 2 | 3 | 20.0 | 30.0 | 20.0 | 30.0 | 0.84 | 18 |
| M | 5 | 6 | 5 | 6 | 22.7 | 27.3 | 22.7 | 27.3 | 0.80 | 17 |
| N | 1 | 1 | 1 | 1 | 25.0 | 25.0 | 25.0 | 25.0 | 0.70 | 22 |
| P | 6 | 5 | 6 | 5 | 27.3 | 22.7 | 27.3 | 22.7 | 0.69 | 21 |
| Q | 3 | 2 | 3 | 2 | 30.0 | 20.0 | 30.0 | 20.0 | 0.68 | 20 |
| R | 2 | 1 | 2 | 1 | 33.3 | 16.7 | 33.3 | 16.7 | 0.68 | 18 |
| S | 5 | 2 | 5 | 2 | 35.7 | 14.3 | 35.7 | 14.3 | 0.70 | 15 |
| T | 3 | 1 | 3 | 1 | 37.5 | 12.5 | 37.5 | 12.5 | 0.735 | 14 |
| U | 4 | 1 | 4 | 1 | 40.0 | 10.0 | 40.0 | 10.0 | 0.76 | 14 |
| V | 5 | 1 | 5 | 1 | 41.7 | 8.3 | 41.7 | 8.3 | 0.78 | 14 |
| W | 6 | 1 | 6 | 1 | 42.9 | 7.1 | 42.9 | 7.1 | 0.775 | 13 |
| X | 9 | 1 | 9 | 1 | 45.0 | 5.0 | 45.0 | 5.0 | 0.77 | 11 |
| Y | 19 | 1 | 19 | 1 | 47.5 | 2.5 | 47.5 | 2.5 | 0.71 | 10 |
| Z | 1 | 0 | 1 | 0 | 50.0 | 0.0 | 50.0 | 0.0 | 0.45 | 10 |

*Alkane = pentane, hexane, heptane, etc.

The methods of the invention can comprise a step of providing one or more samples comprising one or more portions of the lignin deconstruction composition in one or more phases of the multiple-phase solvent system. Some embodiments comprise providing a first sample comprising at least a first portion of the lignin deconstruction composition in a sample aliquot of a first phase of a multiple-phase solvent system. Some embodiments further comprise providing a second sample comprising at least a second portion of the lignin deconstruction composition in a sample aliquot of a second phase of the multiple-phase solvent system. In some versions, the first phase is a light (upper) phase of the multiple-phase solvent system, and/or the second phase is a heavy (lower) phase of the multiple-phase solvent system. In some versions, the first phase is a heavy (lower) phase of the multiple-phase solvent system, and/or the second phase is a light (upper) phase of the multiple-phase solvent system. Depending on the manner in which the samples are generated, the various portions of the lignin deconstruction composition can comprise distinct, split samples of the lignin deconstruction composition as a whole or chemical partitions of the lignin deconstruction composition resulting from differential solubility of various components in the various phases. For example, in some embodiments, the entire lignin deconstruction composition is mixed in single phase of the multiple-phase solvent system. In some embodiments, the entire lignin deconstruction composition is mixed together with all the solvents of the multiple-phase solvent system then partitions with the phases when the multiple-phase solvent system separates. In some embodiments, the lignin deconstruction composition is split into separate lignin deconstruction composition samples and each separate lignin deconstruction composition sample is dissolved into separate phases of the multiple-phase solvent system. Combinations of the foregoing embodiments are also encompassed by the present invention. The liquid deconstruction composition can be in any phase (e.g., liquid, solid, etc.) when used to prepare the samples.

The methods of the invention can comprise a step of providing one or more centrifugal partition chromatography columns. Each column can comprise a plurality of fluidically connected cells. Each column can also comprise a column aliquot of the first phase of the multiple-phase solvent system within the cells and/or a column aliquot of the second phase of the multiple-phase solvent system within the cells. If a column is provided such that it comprises only one of the multiple phases of a multiple-phase solvent system, the column is preferably used in a manner such that another of the phases will be used as a mobile phase. In embodiments of the invention employing a true moving bed configuration, each column preferably comprises both first and second phases therein. Furthermore, embodiments of the invention employing a true moving bed configuration also preferably employ more than one column. The columns in such embodiments will preferably be connected via a fluidic junction therebetween such that the first column, the fluidic junction, and the second column form a continuous, linear, fluidically connected array of the fluidically connected cells comprising a first terminal fluidically connected cell and a second terminal fluidically connected cell.

The methods of the invention can comprise a step of introducing the one or more samples into the one or more columns. This step can be performed by injecting the one or more samples directly in the one or more columns, or in a fluidic junction connecting two or more columns such that the one or more samples subsequently enter into the one or more columns, among other methods. In some versions, the one or more columns comprises a first column of the one or more columns and a second column of the one or more columns, wherein the first column and the second column are connected via a fluidic junction therebetween, and the first column, the fluidic junction, and the second column form a continuous, linear, fluidically connected array of the fluidically connected cells, and the introducing comprises introducing at least one of the one or more samples into the one or more centrifugal partition chromatography columns via the fluidic junction.

The methods of the invention can comprise a step of separating the first component from the second component within the one or more columns. The separating can be performed by introducing and flowing under pressure one or more separation aliquots of the one or more phases of the multiple-phase solvent system through the one or more columns such that the first component and/or the second component flows through the cells of the column(s). In some versions, the separating comprises: flowing a separation aliquot of the first phase of the multiple-phase solvent system through the one or more centrifugal partition chromatography columns and/or flowing a separation aliquot of the second phase of the multiple-phase solvent system through the one or more centrifugal partition chromatography columns. In some versions, the separating comprises: flowing a separation aliquot of the first phase of the multiple-phase solvent system through the one or more centrifugal partition chromatography columns and flowing a separation aliquot of the second phase of the multiple-phase solvent system through the one or more centrifugal partition chromatography columns.

The separating can be performed through eluting with a light phase of the multiple-phase solvent system in ascending mode, eluting with a heavy phase of the multiple-phase solvent system in descending mode, extruding with a light phase of the multiple-phase solvent system in descending mode, and/or extruding with a heavy phase of the multiple-phase solvent system in ascending mode. In some versions, the separating comprises: flowing a separation aliquot of the first phase of the multiple-phase solvent system through the one or more centrifugal partition chromatography columns in an ascending mode and/or flowing a separation aliquot of the second phase of the multiple-phase solvent system through the one or more centrifugal partition chromatography columns in a descending mode. In some versions, the separating comprises: flowing a separation aliquot of the first phase of the multiple-phase solvent system through the one or more centrifugal partition chromatography columns in an ascending mode and flowing a separation aliquot of the second phase of the multiple-phase solvent system through the one or more centrifugal partition chromatography columns in a descending mode.

The separating can be performed under a centrifugal force. The centrifugal force can be generated by spinning the columns during the separating.

The methods of the invention can comprise collecting eluate from the one or more columns. The eluate can comprise a first eluate. In some versions, the first eluate comprises an eluate aliquot of the first phase of the multiple-phase solvent system. In some versions, the first eluate comprises an eluate aliquot of the second phase of the multiple-phase solvent system. The first eluate preferably comprises a proportion of the first component relative to the second component that is greater than a proportion of the first component relative to the second component in the lignin deconstruction composition. The eluate in some embodiments, such as true moving bed embodiments as discussed below, can also comprise a second eluate. In some versions, the second eluate comprises an eluate aliquot of the second phase of the multiple-phase solvent system. In some versions, the second eluate comprises an eluate aliquot of the first phase of the multiple-phase solvent system. The second eluate preferably comprises a proportion of the second component relative to the first component that is greater than a proportion of the second component relative to the first component in the lignin deconstruction composition. The collecting can be performed through eluting with a light phase of the multiple-phase solvent system in ascending mode, eluting with a heavy phase of the multiple-phase solvent system in descending mode, extruding with a light phase of the multiple-phase solvent system in descending mode, and/or extruding with a heavy phase of the multiple-phase solvent system in ascending mode. The collecting can be performed under a centrifugal force. The centrifugal force can be generated by spinning the columns during the collecting.

The introducing, separating, and collecting steps can occur simultaneously, separately, or a combination thereof. In some versions, the introducing, separating, and collecting steps occur simultaneously. In some versions, the introducing is performed first, and the separating and the collecting steps are performed simultaneously after. In some versions, the introducing, the separating, and the collecting steps each occur separately in sequence. Some versions comprise sequentially flowing a separation aliquot of the first phase of the multiple-phase solvent system through the one or more centrifugal partition chromatography columns and collecting the first eluate. Some versions comprise simultaneously flowing a separation aliquot of the first phase of the multiple-phase solvent system through the one or more centrifugal partition chromatography columns and collecting the first eluate. Some versions comprise sequentially flowing a separation aliquot of the second phase of the multiple-phase solvent system through the one or more centrifugal partition chromatography columns and collecting the second eluate. Some versions comprise simultaneously flowing a separation aliquot of the second phase of the multiple-phase solvent system through the one or more centrifugal partition chromatography columns and collecting the second eluate. Some versions comprise sequentially flowing a separation aliquot of the first phase of the multiple-phase solvent system through the one or more centrifugal partition chromatography columns in an ascending mode and collecting the first eluate. Some versions comprise simultaneously flowing a separation aliquot of the first phase of the multiple-phase solvent system through the one or more centrifugal partition chromatography columns in an ascending mode and collecting the first eluate. Some versions comprise sequentially flowing a separation aliquot of the second phase of the multiple-phase solvent system through the one or more centrifugal partition chromatography columns in a descending mode and collecting the second eluate. Some versions comprise simultaneously flowing a separation aliquot of the second phase of the multiple-phase solvent system through the one or more centrifugal partition chromatography columns in a descending mode and collecting the second eluate. Some versions comprise sequentially introducing the first sample into the one or more centrifugal partition chromatography columns, flowing a separation aliquot of the first phase of the multiple-phase solvent system through the one or more centrifugal partition chromatography columns in an ascending mode, and collecting the first eluate. Some versions comprise simultaneously introducing the first sample into the one or more centrifugal partition chromatography columns, flowing a separation aliquot of the first phase of the multiple-phase solvent system through the one or more centrifugal partition chromatography columns in an ascending mode, and collecting the first eluate. Some versions comprise sequentially introducing the second sample into the one or more centrifugal partition chromatography columns, flowing a separation aliquot of the first phase of the multiple-phase solvent system through the one or more centrifugal partition chromatography columns in an ascending mode, and collecting the first eluate. Some versions comprise simultaneously introducing the second sample into the one or more centrifugal partition chromatography columns, flowing a separation aliquot of the first phase of the multiple-phase solvent system through the one or more centrifugal partition chromatography columns in an ascending mode, and collecting the first eluate. Exemplary protocols for the introducing, separating, and collecting steps are provided in the following examples.

In some embodiments, more than one sample is preferably used. The samples preferably comprise a first sample and a second sample. The first sample preferably comprises a first portion of the lignin deconstruction composition in a sample aliquot of a first phase of a multiple-phase solvent system. The second sample preferably comprises a second portion of the lignin deconstruction composition in a sample aliquot of a second phase of the multiple-phase solvent system. As outlined above, multiple centrifugal partition chromatography columns are preferably employed. The centrifugal partition chromatography columns preferably comprise at least a first column and a second column. The columns are preferably connected via a fluidic junction therebetween such that the first column, the fluidic junction, and the second column form a continuous, linear, fluidically connected array of the fluidically connected cells. The fluidically connected array preferably comprises a first terminal fluidically connected cell and a second terminal fluidically connected cell. The first column and the second column each preferably comprise a column aliquot of the first phase of the multiple-phase solvent system within the plurality of fluidically connected cells and a column aliquot of the second phase of the multiple-phase solvent system within the plurality of fluidically connected cells. Both phases are preferably disposed in at least a subset of the cells of each respective column, if not all of the cells of each respective column. The flowing preferably comprises alternately introducing the first sample and the second sample in the fluidic junction. In some versions, each sample is preferably introduced in a flow stream in a continuous manner for a period of time. In some versions, a separation aliquot of the first phase of the multiple-phase solvent system is introduced into the first terminal fluidically connected cell and the first eluate is collected from the second terminal fluidically connected cell. In some versions, a separation aliquot of the first phase of the multiple-phase solvent system is introduced into the first terminal fluidically connected cell and the first eluate is collected from the second terminal fluidically connected cell while the first sample is being introduced in the fluidic junction. In some versions, a flow aliquot of the second phase of the multiple-phase solvent system is introduced into the second terminal fluidically connected cell and the second eluate is collected from the first terminal fluidically connected cell. In some versions, a flow aliquot of the second phase of the multiple-phase solvent system is introduced into the second terminal fluidically connected cell and the second eluate is collected from the first terminal fluidically connected cell while the second sample is being introduced in the fluidic junction. The alternate introduction of the first and second samples can be iterated more than one time, such as two times, three times, or more. A period of time can elapse between the alternate introductions.

In some embodiments, the multiple-phase solvent system comprises, consists essentially of, or consists of alkane, ethyl acetate, methanol, and water.

“Alkane” as used herein refers to a linear, branched, or cyclic saturated hydrocarbon or any combination of such hydrocarbons. In some embodiments, the alkane in the solvent system comprises, consists essentially of, or consists of linear, branched, or cyclic C₂-C₁₂ saturated hydrocarbon(s). In some embodiments, the alkane in the solvent system comprises, consists essentially of, or consists of linear, branched, or cyclic C₄-C₁₀ saturated hydrocarbon(s). In some embodiments, the alkane in the solvent system comprises, consists essentially of, or consists of linear, branched, or cyclic C₄-C₁₀ saturated hydrocarbon(s). In some embodiments, the alkane in the solvent system comprises, consists essentially of, or consists of linear, branched, or cyclic C₄-C₈ saturated hydrocarbon(s). In some embodiments, the alkane in the solvent system comprises, consists essentially of, or consists of pentane, hexane, heptane, isooctane, cyclohexane, and any combination thereof. In some embodiments, the alkane in the solvent system comprises, consists essentially of, or consists of pentane, hexane, heptane, and any combination thereof. In some embodiments, the alkane in the solvent system comprises, consists essentially of, or consists of pentane. In some embodiments, the alkane in the solvent system comprises, consists essentially of, or consists of hexane. In some embodiments, the alkane in the solvent system comprises, consists essentially of, or consists of heptane.

In various embodiments, the multiple-phase solvent system comprises alkane in an amount of at least 10.00%, at least 10.25%, at least 10.50%, at least 10.75%, at least 11.00%, at least 11.25, at least 11.50%, at least 11.75%, at least 12.00%, or at least 12.25%. In various embodiments, the multiple-phase solvent system comprises alkane in an amount up to 23.00%, up to 22.75%, up to 22.50%, up to 22.25%, up to 22.00%, up to 21.75%, up to 21.50%, up to 21.25%, up to 21.00%, up 20.75%, up to 20.50%, up to 20.25%, up to 20.00%, up to 19.75%, up to 19.50%, up to 19.25%, up to 19.00%, up to 18.75%, up to 18.50%, up to 18.25%, up to 18.00%, up to 17.75%, up to 17.50%, up to 17.25%, up to 17.00%, up to 16.75%, up to 16.50%, up to 16.25%, up to 16.00%, up to 15.75%, up to 15.50%, up to 15.25%, up to 15.00%, up to 14.75%, up to 14.50%, up to 14.25%, up to 14.00%, up to 13.75%, up to 13.50%, up to 13.25%, up to 13.00%, or up to 12.75%. In some embodiments, the multiple-phase solvent system comprises alkane in an amount of about 12.5%. Such amounts refer to the v/v percent of the alkane in the multiple-phase solvent system.

In various embodiments, the multiple-phase solvent system comprises ethyl acetate in an amount of at least 27.00%, at least 27.25%, at least 27.50%, at least 27.75%, at least 28.00%, at least 28.25%, at least 28.50%, at least 28.75%, at least 29.00%, at least 29.25%, at least 29.50%, at least 29.75%, at least 30.00%, at least 30.25%, at least 30.50%, at least 30.75%, at least 31.00%, at least 30.25%, at least 30.50%, at least 30.75%, at least 32.00%, at least 30.25%, at least 30.50%, at least 30.75%, at least 33.00%, at least 30.25%, at least 30.50%, at least 30.75%, at least 34.00%, at least 30.25%, at least 30.50%, at least 30.75%, at least 35.00%, at least 30.25%, at least 30.50%, at least 30.75%, at least 36.00%, at least 30.25%, at least 30.50%, at least 30.75%, at least 37.00%, or at least 30.25%. In various embodiments, the multiple-phase solvent system comprises ethyl acetate in an amount up to 40.00%, up to 39.75%, up to 39.50%, up to 39.25%, up to 38.75%, up to 38.50%, up to 38.25%, or up to 37.75%. In some embodiments, the multiple-phase solvent system comprises ethyl acetate in an amount of about 37.5%. Such amounts refer to the v/v percent of the ethyl acetate in the multiple-phase solvent system.

In various embodiments, the multiple-phase solvent system comprises methanol in an amount of at least 10.00%, at least 10.25%, at least 10.50%, at least 10.75%, at least 11.00%, at least 11.25, at least 11.50%, at least 11.75%, at least 12.00%, or at least 12.25%. In various embodiments, the multiple-phase solvent system comprises methanol in an amount up to 23.00%, up to 22.75%, up to 22.50%, up to 22.25%, up to 22.00%, up to 21.75%, up to 21.50%, up to 21.25%, up to 21.00%, up 20.75%, up to 20.50%, up to 20.25%, up to 20.00%, up to 19.75%, up to 19.50%, up to 19.25%, up to 19.00%, up to 18.75%, up to 18.50%, up to 18.25%, up to 18.00%, up to 17.75%, up to 17.50%, up to 17.25%, up to 17.00%, up to 16.75%, up to 16.50%, up to 16.25%, up to 16.00%, up to 15.75%, up to 15.50%, up to 15.25%, up to 15.00%, up to 14.75%, up to 14.50%, up to 14.25%, up to 14.00%, up to 13.75%, up to 13.50%, up to 13.25%, up to 13.00%, or up to 12.75%. In some embodiments, the multiple-phase solvent system comprises methanol in an amount of about 12.5%. Such amounts refer to the v/v percent of the methanol in the multiple-phase solvent system.

In various embodiments, the multiple-phase solvent system comprises water in an amount of at least 27.00%, at least 27.25%, at least 27.50%, at least 27.75%, at least 28.00%, at least 28.25%, at least 28.50%, at least 28.75%, at least 29.00%, at least 29.25%, at least 29.50%, at least 29.75%, at least 30.00%, at least 30.25%, at least 30.50%, at least 30.75%, at least 31.00%, at least 30.25%, at least 30.50%, at least 30.75%, at least 32.00%, at least 30.25%, at least 30.50%, at least 30.75%, at least 33.00%, at least 30.25%, at least 30.50%, at least 30.75%, at least 34.00%, at least 30.25%, at least 30.50%, at least 30.75%, at least 35.00%, at least 30.25%, at least 30.50%, at least 30.75%, at least 36.00%, at least 30.25%, at least 30.50%, at least 30.75%, at least 37.00%, or at least 30.25%. In various embodiments, the multiple-phase solvent system comprises water in an amount up to 40.00%, up to 39.75%, up to 39.50%, up to 39.25%, up to 38.75%, up to 38.50%, up to 38.25%, or up to 37.75%. In some embodiments, the multiple-phase solvent system comprises water in an amount of about 37.5%. Such amounts refer to the v/v percent of the water in the multiple-phase solvent system.

In some versions, the multiple-phase solvent system comprises: alkane in an amount of at least 8% and up to 25% v/v of the multiple-phase solvent system; ethyl acetate in an amount of at least 25% and up to 42% v/v of the multiple-phase solvent; methanol in an amount of at least 8% and up to 25% v/v of the multiple-phase solvent system; and water in an amount of at least 25% and up to 42% v/v of the multiple-phase solvent. In some versions, the multiple-phase solvent system comprises: alkane in an amount of at least 10% and up to 23% v/v of the multiple-phase solvent system; ethyl acetate in an amount of at least 27% and up to 40% v/v of the multiple-phase solvent; methanol in an amount of at least 10% and up to 23% v/v of the multiple-phase solvent system; and water in an amount of at least 27% and up to 40% v/v of the multiple-phase solvent.

In some versions, the multiple-phase solvent system is a first multiple-phase solvent system comprising: alkane in an amount of at least 10% and up to 14% v/v of the multiple-phase solvent system; ethyl acetate in an amount of at least 36% and up to 40% v/v of the multiple-phase solvent; methanol in an amount of at least 10% and up to 14% v/v of the multiple-phase solvent system; and water in an amount of at least 36% and up to 40% v/v of the multiple-phase solvent. In some versions, the first multiple-phase solvent system comprises: alkane in an amount of at least 10.5% and up to 14.0% v/v of the multiple-phase solvent system; ethyl acetate in an amount of at least 35.0% and up to 39.5% v/v of the multiple-phase solvent; methanol in an amount of at least 10.5% and up to 14.0% v/v of the multiple-phase solvent system; and water in an amount of at least 35.0% and up to 39.5% v/v of the multiple-phase solvent.

In some versions, the multiple-phase solvent system is a second multiple-phase solvent system comprising: alkane in an amount of at least 17% and up to 23% v/v of the multiple-phase solvent system; ethyl acetate in an amount of at least 27% and up to 33% v/v of the multiple-phase solvent; methanol in an amount of at least 17% and up to 23% v/v of the multiple-phase solvent system; and water in an amount of at least 27% and up to 33% v/v of the multiple-phase solvent. In some versions, the second multiple-phase solvent system comprises: alkane in an amount of at least 17.5% and up to 22.0% v/v of the multiple-phase solvent system; ethyl acetate in an amount of at least 28.0% and up to 32.5% v/v of the multiple-phase solvent; methanol in an amount of at least 17.5% and up to 22.0% v/v of the multiple-phase solvent system; and water in an amount of at least 28.0% and up to 32.5% v/v of the multiple-phase solvent.

It is understood that the above descriptions of the multiple-phase solvent system comprising, consisting essentially of, or consisting of the various components in the various proportions refers to the component and proportions present when initially mixed and prior to separation into the different phases.

In some embodiments, the methods herein can be employed to separate aromatic monomers from aromatic oligomers originally present in a lignin deconstruction composition. Accordingly, the first component in some embodiments comprises, consists essentially of, or consists of one or more aromatic monomers. In some embodiments, the one or more aromatic monomers can comprise, consist essentially of, or consist of any one, any two, any three, any four, any five, any six, any seven, any eight, any nine, or each of para-hydroxybenzaldehyde, para-hydroxybenzoic acid, vanillin, vanillic acid, acetovanillone, 5-formyl-2-hydroxy-3-methoxybenzoic acid, 5-carboxyvanillic acid, syringaldehyde, syringic acid, and acetosyringone. In some embodiments, the one or more aromatic monomers can comprise, consist essentially of, or consist of any one, any two, any three, any four, any five, any six, any seven, or each of para-hydroxybenzaldehyde, para-hydroxybenzoic acid, vanillin, vanillic acid, acetovanillone, 5-formyl-2-hydroxy-3-methoxybenzoic acid, syringaldehyde, and acetosyringone. The second component can comprise, consist essentially of or consist of one or more aromatic oligomers. In some embodiments, second component comprises, consists essentially of, or consist of one or more hydrophilic aromatic oligomers.

In some versions, the multiple-phase solvent system is the first multiple phase solvent system; the first phase is an upper phase of the first multiple phase solvent system; the second phase is a lower phase of the first multiple phase solvent system; the separating and collecting each comprises flowing a separation aliquot of the first phase of the multiple-phase solvent system through the one or more centrifugal partition chromatography columns in an ascending mode and flowing a separation aliquot of the second phase of the multiple-phase solvent system through the one or more centrifugal partition chromatography columns in a descending mode; the first component comprises, consists essentially of, or consists of any one or more, any two or more, any three or more, any four or more, any five or more, any six or more, any seven or more, any eight or more, any nine or more, or each of para-hydroxybenzaldehyde, para-hydroxybenzoic acid, vanillin, vanillic acid, acetovanillone, 5-formyl-2-hydroxy-3-methoxybenzoic acid, 5-carboxyvanillic acid, syringaldehyde, syringic acid, and acetosyringone; and the second component comprises an aromatic oligomer.

In some versions, the multiple-phase solvent system is the second multiple phase solvent system; the first phase is an upper phase of the first multiple phase solvent system; the second phase is a lower phase of the first multiple phase solvent system; the separating comprises flowing a separation aliquot of the first phase of the multiple-phase solvent system through the one or more centrifugal partition chromatography columns in an ascending mode and flowing a separation aliquot of the second phase of the multiple-phase solvent system through the one or more centrifugal partition chromatography columns in a descending mode; the collecting the first eluate comprises flowing a separation aliquot of the first phase of the multiple-phase solvent system through the one or more centrifugal partition chromatography columns in a descending mode; the first component comprises, consists essentially of, or consists of any one or more, any two or more, any three or more, any four or more, any five or more, any six or more, any seven or more, or each of para-hydroxybenzaldehyde, para-hydroxybenzoic acid, vanillin, vanillic acid, acetovanillone, 5-formyl-2-hydroxy-3-methoxybenzoic acid, syringaldehyde, and acetosyringone; and the collecting the second eluate comprises flowing a separation aliquot of the first phase of the multiple-phase solvent system through the one or more centrifugal partition chromatography columns in an ascending mode and flowing a separation aliquot of the second phase of the multiple-phase solvent system through the one or more centrifugal partition chromatography columns in a descending mode; and the second component comprises an aromatic oligomer.

“Aliquot” as used herein refers to a particular embodiment, incarnation, instantiation, or manifestation (e.g., a sample, portion, amount, volume, or flow stream) of a particular type of liquid (e.g., a given phase of a multiple-phase solvent system). A given aliquot can be referred to in a particular context or used for a particular purpose (e.g., a sample aliquot, a column aliquot, or an eluate aliquot of a first or second phase of a multiple-solvent system). The reference to two more separate aliquots of a particular type of liquid (e.g., a given phase of a multiple-phase solvent system) accordingly does not imply that the aliquots were obtained from a single, physical master sample of that liquid, even though it is possible that they can be, as the separate aliquots can be independently generated or obtained from independently generated master samples. Further, unless the context dictates otherwise, the reference to an “aliquot” does not necessarily imply a determinate volume, particularly when used with reference to a flow stream (e.g., an eluate aliquot or flow aliquot).

“Ascending mode” refers to the flowing of a liquid through cells of a centrifugal partition chromatography column against the direction of the applied centrifugal force (toward the rotational axis). When the cells are filled with a light and heavy phase, the direction of flow in ascending mode within each cell will be in the direction from the heavy phase to the light phase.

“Descending mode” refers to the flowing of a liquid through cells of a centrifugal partition chromatography column in the same direction as the applied centrifugal force (away from the rotational axis). When the cells are filled with a light and heavy phase, the direction of flow in descending mode within each cell will be in the direction from the light phase to the heavy phase.

“Elution” refers to flowing a particular liquid phase through cells of a centrifugal partition chromatography column in a direction such that the particular phase is downstream of another phase in each cell. Elution can therefore occur either by flowing an upper (lighter) phase in ascending mode or by flowing a lower (heavier) phase in descending mode.

“Extrusion” refers to flowing a particular liquid phase through cells of a centrifugal partition chromatography column in a direction such that the particular phase is upstream of another phase in each cell. Extrusion can therefore occur either by flowing a lower (heavier) phase in ascending mode of by flowing an upper phase (lighter) phase in descending mode. “Eluate” refers to any fluid, phase, or substance collected from a centrifugal partition chromatography column, whether performed during elution or extrusion. The collecting of eluate can be performed through elution or extrusion. “Light phase” and “upper phase” are used herein to refer to a phase in a multiple-phase solvent system that partitions above at least one other phase in multiple-phase solvent system. The light or upper phase will accordingly partition above the heavy or lower phase.

“Heavy phase” and “lower phase” are used herein to refer to a phase in a multiple-phase solvent system that partitions below at least one other phase in multiple-phase solvent system. The heavy or lower phase will accordingly partition below the light or upper phase.

In a two-phase multiple-phase solvent system, the phases will include only a light/upper phase and a heavy/lower phase.

Some methods of the invention are directed to methods of separating lignin deconstruction feedstocks using continuous centrifugal partition chromatography. The methods can comprise the use of continuous centrifugal partition chromatography for separating various components of lignin deconstruction feedstocks, such as the continuous binary separation of aromatic monomers from oligomers.

“Portion” as used herein can refer to any amount of a given substance, whether the entire amount or a sub-part thereof.

The elements and method steps described herein can be used in any combination whether explicitly described or not.

All combinations of method steps as used herein can be performed in any order, unless otherwise specified or clearly implied to the contrary by the context in which the referenced combination is made.

As used herein, the singular forms “a,” “an,” and “the” include plural referents unless the content clearly dictates otherwise.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All patents, patent publications, and peer-reviewed publications (i.e., “references”) cited herein are expressly incorporated by reference to the same extent as if each individual reference were specifically and individually indicated as being incorporated by reference. In case of conflict between the present disclosure and the incorporated references, the present disclosure controls.

It is understood that the invention is not confined to the particular construction and arrangement of parts herein illustrated and described, but embraces such modified forms thereof as come within the scope of the claims.

### EXAMPLES

### Materials and Methods

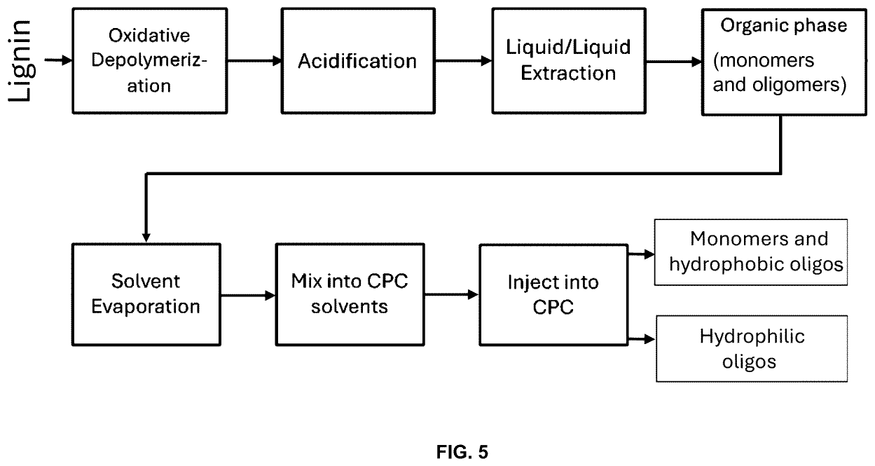

A process for deconstructing lignin to aromatics and purifying the aromatics via continuous binary separation of aromatics and oligomers using centrifugal partition chromatography (CPC) was performed as shown in FIG. 5 and described below. Four different CPC protocols were used: batch CPC, continuous CPC, stacked injection CPC, and trapping CPC, as described in further detail below.

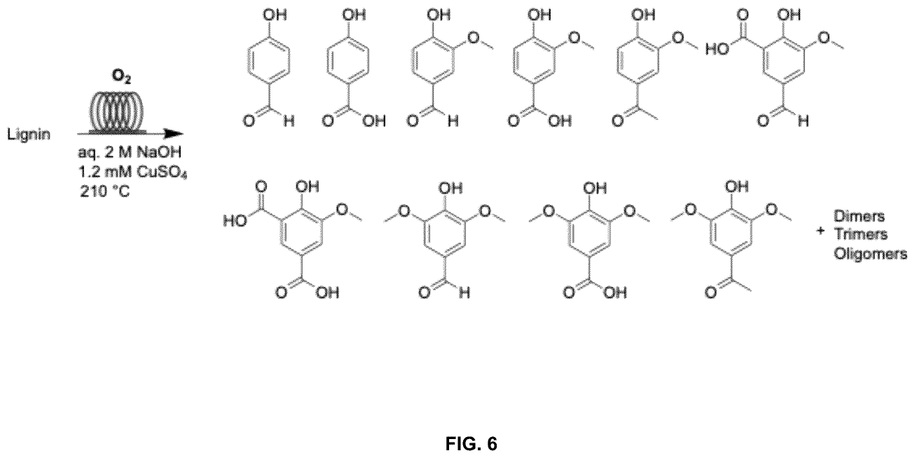

Oxidative depolymerization of lignin: Lignin (poplar Cu-AHP lignin for batch and continuous CPC; softwood kraft lignin for stacked injection and trapping CPC) was oxidatively deconstructed using 2 M NaOH solution, CuSO₄·5H₂O, and oxygen as oxidant in a continuous flow reactor (FIG. 6). Similar results were observed in batch reactions using alkaline conditions at high temperature with copper (II) sulfate catalyst under pressurized O₂. The black liquor from this process was used in the acidification step.

Acidification: The black liquor from oxidative depolymerization was alkaline with a pH of ~14. For batch and continuous CPC, the black liquor was neutralized and acidified with 37% HCl to pH 2. The dark liquor became light brown after this. For stacked injection CPC, the black liquor was neutralized to pH 7 with concentrated H₂SO₄. For trapping mode, the black liquor was neutralized and acidified to pH 2 with concentrated H₂SO₄.

Liquid/liquid extraction: The acidified liquor was extracted using a 1:1 volume ratio of ethyl acetate to partition all the organics (monomers, dimers, trimers and hydrophobic/hydrophilic oligomers) to the organic phase.

Solvent evaporation: The ethyl acetate solvent was removed by distillation (using a rotary evaporator; other methods of distillation can be used) to concentrate the organics.

Mix organic into CPC solvents: The dried down organics were redissolved in the CPC solvent of choice. For the batch CPC, the organics were dissolved in monophasic 1:1 MeOH/water. Biphasic solvent systems were used to dissolve the organics for the continuous, stacked injection, and trapping CPC. For these, the dissolution occurred by generating the solvent, allowing the solvent to separate into different phases, separating the phases, and dissolving the organics in one or both separate phases. For continuous CPC, the organics were split and dissolved in each phase of Arizona H solvent (1:3:1:3 heptane/ethyl acetate/MeOH/water v/v/v/v). For stacked injection CPC, the organics were all dissolved in the upper phase of Arizona H solvent (1:3:1:3 heptane/ethyl acetate/MeOH/water v/v/v/v). For trapping CPC, the organics were split and dissolved in Arizona L solvent (2:3:2:3 heptane/ethyl acetate/MeOH/water v/v/v/v).

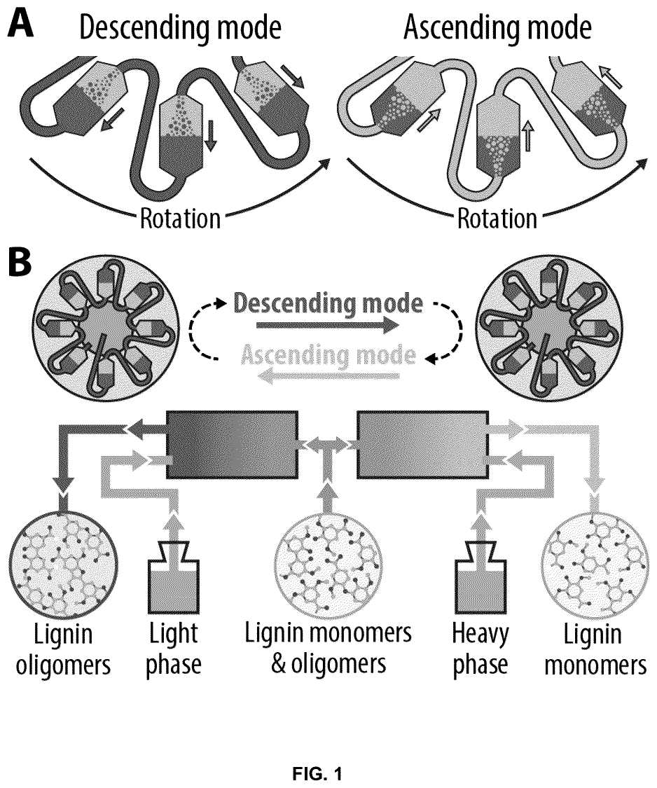

CPC column loading: For all of the CPC methods except the batch CPC, the same solvent employed as the dissolution solvent was used as the CPC separation solvent to load the CPC column (Arizona H for continuous and stacked injection CPC; Arizona L for trapping CPC). Arizona H was used as the separation solvent in the batch CPC. The batch CPC used one rotor and did not switch between ascending and descending. The continuous, stacked injection, and trapping CPC used two rotors with a sample injection port between (as shown in FIGS. 1 (B) and 4).

### CPC Protocols:

### Batch CPC:

Injection of organics dissolved in 1:1 MeOH/water;
Elution by flowing of Arizona H upper phase in ascending mode to collect monomers;
Extrusion by flowing of Arizona H lower phase in ascending mode to collect oligomers.

### Continuous CPC:

Injection of organics dissolved in Arizona H upper phase during elution of Arizona H upper phase in ascending mode to collect hydrophobic oligomers and monomers;
Injection of organics dissolved in Arizona H lower phase during elution of Arizona H lower phase in descending mode to collect hydrophilic oligomers.

### Stacked Injection CPC:

Injection of organics dissolved in Arizona H upper phase;
Elution by flowing Arizona H upper phase in ascending mode to collect hydrophobic oligomers first, followed by collection of monomers second;
Elution by flowing Arizona H lower phase in descending mode to collect hydrophilic oligomers.

### Trapping CPC:

Injection of organics dissolved in Arizona L upper phase;
Injection of organics dissolved in Arizona L lower phase;
Elution by flowing Arizona L upper phase in ascending mode to collect hydrophobic oligomers;
Elution by flowing Arizona L lower phase in descending mode to collect hydrophilic oligomers;
Repeat ascending and descending elutions in sequence several times;
Extrusion by flowing Arizona L upper phase in descending mode to collect monomers.

Purity and recovery calculations: The sample fractions were collected after the separation by CPC and concentrated. An amount was dissolved in methanol and the aromatics were quantified using either a high-performance liquid chromatography (HPLC) or an ultra-performance liquid chromatography (UPLC) system.

### Cpc Summaries:

### Batch CPC Conditions (TMB 1000)

| | |
|---|---|
| Elution rotor speed | 1400 mL/min |
| Elution flowrate | 30 mL/min |
| Sample concentration | 10 g in 15 mL solvent |
| Injection solvent | 1:1 MeOH/water |
| Separation solvent | Arizona H-1:3:1:3 heptane/ethyl acetate/MeOH/water |
| Mode | Ascending elution with upper phase, ascending |
| | extrusion with lower phase |

### Batch CPC Results

| | |
|---|---|
| Purity of aromatics | Up to 75 wt % |
| Aromatic recovery | 95% recovered monomers/injected monomers |
| | (wt/wt) |
| Productivity | 30 g crude lignin depolymerization mixture/day |

### Continuous CPC Conditions (TMB 250)

| | |
|---|---|
| Elution flowrate | 60 mL/min |
| Injection flowrate | 20 mL/min |
| Cycle time | 1 min |
| Sample | 10 g in 500 mL solvent |
| concentration | |
| Injection solvent | Arizona H-1:3:1:3 heptane/ethyl acetate/MeOH/water |
| | (upper and lower phases) |
| Mode | Ascending elution with upper phase, descending |
| | elution with lower phase |
| Separation solvent | Arizona H-1:3:1:3 heptane/ethyl acetate/MeOH/water |

### Continuous CPC Results

| | |
|---|---|
| Purity of aromatics | 70 wt % |
| Aromatic recovery | ~100% recovered monomers/injected monomers |
| | (wt./wt.) |
| Productivity | 80 to 100 g crude lignin depolymerization |
| (TMB 2000) | mixture/h (40-50 g crude lignin depolymerization |
| | mixture/h per liter CPC volume) |

### Stacked Injection CPC Conditions (RotaChrom CPC)

| | |
|---|---|
| Elution flowrate | 200 mL/min |
| Injection flowrate | 100 mL/min |
| Cycle time | 1 min injection, 4 min descending, 9 min ascending |
| Sample | 100 g in 1000 mL solvent |
| concentration | |
| Injection solvent | Arizona H-1:3:1:3 heptane/ethyl acetate/MeOH/water |
| | (upper phase only) |
| Mode | Ascending elution with upper phase, descending |
| | elution with lower phase |
| Separation solvent | Arizona H-1:3:1:3 heptane/ethyl acetate/MeOH/water |

### Stacked Injection CPC Results

| | |
|---|---|
| Purity of aromatics | >70 wt % |
| Aromatic recovery | ~90% recovered monomers/injected monomers |
| | (wt./wt.) |
| Productivity | 60 g crude lignin depolymerization mixture/h |
| (RotaChrom CPC) | (14 g crude lignin depolymerization mixture/h |
| | per liter CPC volume) |

### Trapping CPC Conditions (RotaChrom CPC)

| | |
|---|---|
| Elution flowrate | 200 mL/min |
| Injection flowrate | 100 mL/min |
| Injection volume | 600 mL |
| Cycle time | 2 min descending and 2 min ascending repeated |
| | 8 times, 20 min extrusion |
| Sample concentration | 88 g in 1000 mL solvent |
| Injection solvent | Arizona L-2:3:2:3 heptane/ethyl acetate/MeOH/water |
| | (upper and lower phases) |
| Mode | Ascending elution with upper phase, descending |
| | elution with lower phase, and descending extrusion |
| | with upper phase |
| Separation solvent | Arizona L-2:3:2:3 heptane/ethyl acetate/MeOH/water |

### Trapping CPC Results

| | |
|---|---|
| Purity of aromatics | 70 wt % |
| Aromatic recovery | ~100% recovered monomers/injected monomers |
| | (wt./wt.) |
| Productivity | 50 g crude lignin depolymerization mixture/h |
| (RotaChrom CPC) | (12 g crude lignin depolymerization mixture/h |
| | per liter CPC volume) |

In the CPC methods provided herein, pentane, hexane, and mixtures of two or more of pentane, hexane, and heptane can be used in place of heptane in the solvent systems. Other alkanes (e.g., isooctane, cyclohexane, etc.) and mixtures thereof can also be used in addition to or place of heptane in the solvent systems.

### Results

Lignin deconstruction: Lignin was deconstructed using a continuous flow process as described above to generate mixtures of monomeric phenol compounds (e.g., para-hydroxybenzaldehyde, para-hydroxybenzoic acid, vanillin, vanillic acid, acetovanillone, 5-formyl-2-hydroxy-3-methoxybenzoic acid, 5-carboxyvanillic acid, syringaldehyde, syringic acid, and acetosyringone) and oligomers.

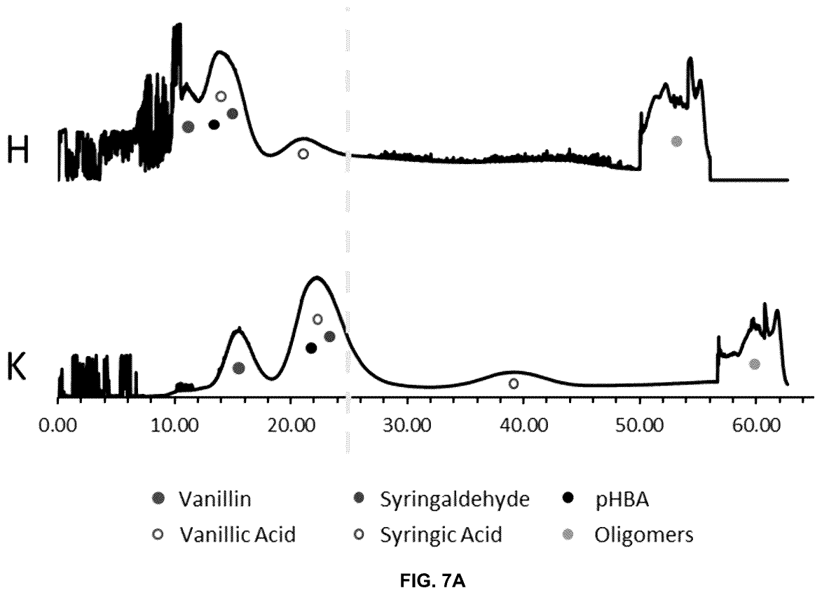

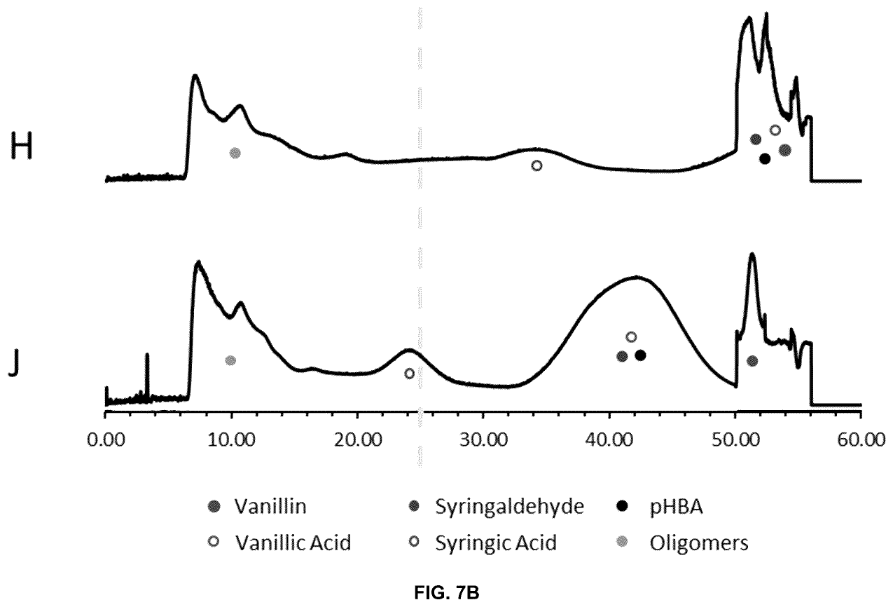

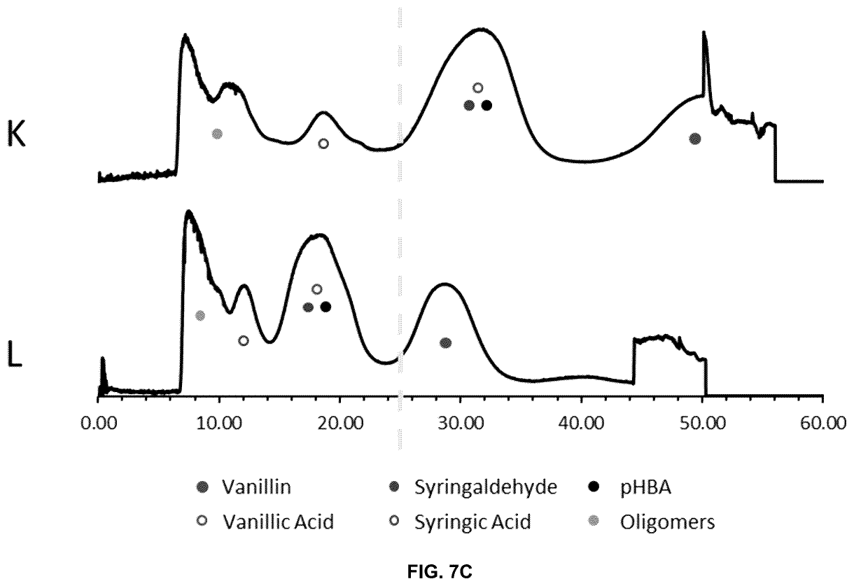

We screened the entire Arizona solvent series (Berthod et al. 2005) using heptane as an exemplary alkane in batch CPC to find suitable solvent systems for the binary separation of the monomers from the oligomers. FIGS. 7A-7C show selected batch CPC chromatograms for Arizona H and K (in ascending modes) and H, J, K, and L (in descending modes). The K_{d} is defined in the chromatogram as the 25 minutes mark based on the column volume and instrument parameters. Arizona H was superior for separating monomers (e.g., vanillin, vanillic acid, syringaldehyde, syringic acid, and para-hydroxybenzoic acid (pHBA)) from oligomers.

We established the following criteria for the binary separation of small molecule aromatics (para-hydroxybenzaldehyde, para-hydroxybenzoic acid, vanillin, vanillic acid, acetovanillone, 5-formyl-2-hydroxy-3-methoxybenzoic acid, 5-carboxyvanillic acid, syringaldehyde, syringic acid, and acetosyringone) from oligomers using continuous and stacked injection CPC:
A distribution ratio (K_{d}) of all the small molecule aromatics >1 and a distribution ratio (K_{d}) of oligomers <1; or
A distribution ratio (K_{d}) of all the small molecule aromatics <1 and a distribution ratio (K_{d}) of oligomers >1.

Arizona H was identified as a suitable solvent system for both of the separations. Arizona J and K did not meet the K_{d} criteria and hence were not suitable for this type of binary separation.

In the continuous binary separation, the sample was introduced continuously and concurrent with elution, injecting the components dissolved in upper phase during ascending mode and the components dissolved in lower phase during descending mode. All components with K_{d}>1 including all the target small molecule aromatics and hydrophobic oligomers were collected in upper phase during upper phase elution, and hydrophilic oligomers were collected in lower phase during lower phase elution. The continuous CPC was capable of separating all aromatic monomers present in the lignin deconstruction sample (para-hydroxybenzoic acid, vanillin, vanillic acid, acetovanillone, syringaldehyde, syringic acid, and acetosyringone) from oligomers. Para-hydroxybenzaldehyde, 5-formyl-2-hydroxy-3-methoxybenzoic acid, and 5-carboxyvanillic acid were not present in the initial lignin deconstruction sample but are predicted to be separated based on the K_{d} criteria outlined above.

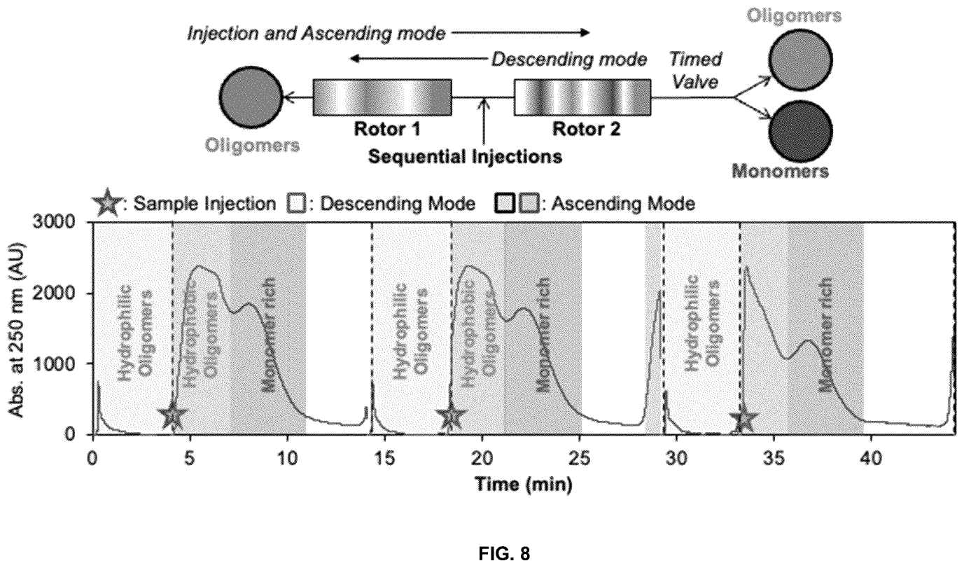

Results for an exemplary stacked injection separation are shown in FIG. 8. In the stacked injection CPC, a single injection of sample dissolved in Arizona H upper phase was introduced at the beginning of each ascending cycle. Then, the upper phase is flowed in ascending mode, and the hydrophobic oligomers are collected. A fraction collector change occurs around the midpoint of this ascending cycle, and collection begins of the small molecule aromatics. Flow is then switched to lower phase in descending mode to collect hydrophilic oligomers. This process is repeated. All the monomers present in the stacked injection lignin deconstruction sample (para-hydroxybenzaldehyde, vanillin, and acetovanillone) were successfully collected and separated from the hydrophilic monomers. Para-hydroxybenzoic acid, vanillic acid, 5-formyl-2-hydroxy-3-methoxybenzoic acid, 5-carboxyvanillic acid, syringaldehyde, syringic acid, and acetosyringone were not present in the initial lignin deconstruction sample but are predicted to be separated based on the K_{d} criteria outlined above.

We established the following criteria for the binary separation of small molecule aromatics (para-hydroxybenzaldehyde, para-hydroxybenzoic acid, vanillin, vanillic acid, acetovanillone, 5-formyl-2-hydroxy-3-methoxybenzoic acid, syringaldehyde, and acetosyringone) from oligomers using trapping CPC:
A distribution ratio of all the small molecule aromatics 0.5<K_{d}<2 and a distribution ratio of oligomers K_{d}<0.4 and/or K_{d}>2.2.

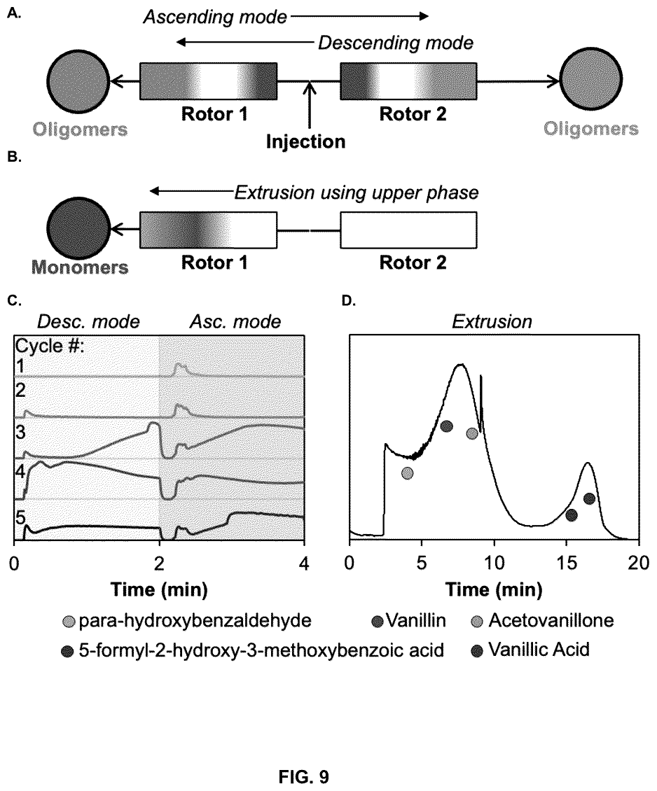

Arizona L was deemed to be suitable for the trapping CPC. FIG. 9 shows an exemplary trapping experiment where para-hydroxybenzaldehyde, vanillin, vanillic acid, acetovanillone, and 5-formyl-2-hydroxy-3-methoxybenzoic acid were collected. The oligomeric material was collected in upper and lower phases during the initial “trapping” ascending and descending elution cycles. The “trapped” monomer components are then recovered during an extrusion, generally by flowing the upper phase in descending mode. Para-hydroxybenzoic acid, syringaldehyde, and acetosyringone were not present in the initial lignin deconstruction sample but are predicted to be separated based on the K_{d} criteria outlined above.

### REFERENCES

Alherech M, Omolabake S, Holland C M, Klinger G E, Hegg E L, Stahl S S. From Lignin to Valuable Aromatic Chemicals: Lignin Depolymerization and Monomer Separation via Centrifugal Partition Chromatography. ACS Cent. Sci. 2021, 7, 11, 1831-1837.
Berthod, Alain & Hassoun, Mahmoud & Ruiz-Angel, María José. Alkane effect in the Arizona liquid system used in counter current chromatography. Analytical and bioanalytical chemistry. 2005, 383, 327-40.
Cui Y, Weeda E P, Omolabake S, Karlen S D, Holland C M, Stahl S S. Oxidative Catalytic Fractionation of Lignocellulosic Biomass Using a Co—N-P-C Catalyst and One-Step Isolation of Aromatic Monomers via Centrifugal Partition Chromatography. ACS Sustainable Chem. Eng. 2024, 12, 26, 9795-9804.

1. A method of separating a first component and a second component of a lignin deconstruction composition, the method comprising:
providing one or more samples, wherein the one or more samples comprises:
a first sample comprising a first portion of the lignin deconstruction composition in a sample aliquot of a first phase of a multiple-phase solvent system; and/or
a second sample comprising a second portion of the lignin deconstruction composition in a sample aliquot of a second phase of the multiple-phase solvent system;
providing one or more centrifugal partition chromatography columns, each column comprising a plurality of fluidically connected cells and:
a column aliquot of the first phase of the multiple-phase solvent system within the plurality of fluidically connected cells; and/or
a column aliquot of the second phase of the multiple-phase solvent system within the plurality of fluidically connected cells;
introducing at least one of the one or more samples into the one or more centrifugal partition chromatography columns;
separating the first component from the second component within the one or more columns; and
collecting eluate from the one or more columns, wherein the eluate comprises:
a first eluate comprising a proportion of the first component relative to the second component that is greater than a proportion of the first component relative to the second component in the lignin deconstruction composition; and/or
a second eluate comprising a proportion of the second component relative to the first component that is greater than a proportion of the second component relative to the first component in the lignin deconstruction composition.

2. The method of claim 1, wherein the first component comprises one or more aromatic monomers.

3. The method of claim 2, wherein the one or more aromatic monomers comprise any one or more, any two or more, any three or more, any four or more, any five or more, any six or more, any seven or more, any eight or more, any nine or more, or each of para-hydroxybenzaldehyde, para-hydroxybenzoic acid, vanillin, vanillic acid, acetovanillone, 5-formyl-2-hydroxy-3-methoxybenzoic acid, 5-carboxyvanillic acid, syringaldehyde, syringic acid, and acetosyringone.

4. The method of claim 1, wherein the second component comprises an aromatic oligomer.

5. The method of claim 1, wherein the lignin deconstruction composition comprises chemically depolymerized lignin.

6-7. (canceled)

8. The method of claim 1, wherein the multiple-phase solvent system comprises alkane, ethyl acetate, methanol, and water.

9. The method of claim 1, wherein the multiple-phase solvent system comprises:
alkane in an amount of at least 10% and up to 23% v/v of the multiple-phase solvent system;
ethyl acetate in an amount of at least 27% and up to 40% v/v of the multiple-phase solvent;
methanol in an amount of at least 10% and up to 23% v/v of the multiple-phase solvent system; and
water in an amount of at least 27% and up to 40% v/v of the multiple-phase solvent.

10. The method of claim 1, wherein the multiple-phase solvent system comprises a first multiple-phase solvent system comprising:
alkane in an amount of at least 10% and up to 14% v/v of the multiple-phase solvent system;
ethyl acetate in an amount of at least 36% and up to 40% v/v of the multiple-phase solvent;
methanol in an amount of at least 10% and up to 14% v/v of the multiple-phase solvent system; and
water in an amount of at least 36% and up to 40% v/v of the multiple-phase solvent.

11. The method of claim 1, wherein the multiple-phase solvent system comprises a second multiple-phase solvent system comprising:
alkane in an amount of at least 17% and up to 23% v/v of the multiple-phase solvent system;
ethyl acetate in an amount of at least 27% and up to 33% v/v of the multiple-phase solvent;
methanol in an amount of at least 17% and up to 23% v/v of the multiple-phase solvent system; and
water in an amount of at least 27% and up to 33% v/v of the multiple-phase solvent.

12. The method of claim 1, wherein the one or more columns each comprises the column aliquot of the first phase of the multiple-phase solvent system and the column aliquot of the second phase of the multiple-phase solvent system.

13. (canceled)

14. The method of claim 1, wherein the introducing comprises introducing the first sample into the one or more centrifugal partition chromatography columns, wherein the first phase of the multiple-phase solvent system is an upper phase of the multiple-phase solvent system.

15. The method of claim 14, wherein the introducing comprises introducing the second sample into the one or more centrifugal partition chromatography columns, wherein the second phase of the multiple-phase solvent system is a lower phase of the multiple-phase solvent system.

16. The method of claim 1, wherein the separating comprises: flowing a separation aliquot of the first phase of the multiple-phase solvent system through the one or more centrifugal partition chromatography columns and/or flowing a separation aliquot of the second phase of the multiple-phase solvent system through the one or more centrifugal partition chromatography columns.

17. The method of claim 1, wherein the separating comprises: flowing a separation aliquot of the first phase of the multiple-phase solvent system through the one or more centrifugal partition chromatography columns in an ascending mode and/or flowing a separation aliquot of the second phase of the multiple-phase solvent system through the one or more centrifugal partition chromatography columns in a descending mode.

18. The method of claim 1, comprising:
simultaneously flowing a separation aliquot of the first phase of the multiple-phase solvent system through the one or more centrifugal partition chromatography columns and collecting the first eluate; and/or
simultaneously flowing a separation aliquot of the second phase of the multiple-phase solvent system through the one or more centrifugal partition chromatography columns and collecting the second eluate.

19. The method of claim 1, comprising:
simultaneously flowing a separation aliquot of the first phase of the multiple-phase solvent system through the one or more centrifugal partition chromatography columns in an ascending mode and collecting the first eluate; and/or
simultaneously flowing a separation aliquot of the second phase of the multiple-phase solvent system through the one or more centrifugal partition chromatography columns in a descending mode and collecting the second eluate.

20. The method of claim 1, comprising:
simultaneously introducing the first sample into the one or more centrifugal partition chromatography columns, flowing a separation aliquot of the first phase of the multiple-phase solvent system through the one or more centrifugal partition chromatography columns in an ascending mode, and collecting the first eluate; and/or
simultaneously introducing the second sample into the one or more centrifugal partition chromatography columns, flowing a separation aliquot of the first phase of the multiple-phase solvent system through the one or more centrifugal partition chromatography columns in an ascending mode, and collecting the first eluate.

21. The method of claim 1, wherein the first phase of the multiple-phase solvent system is an upper phase of the multiple-phase solvent system, and the second phase of the multiple-phase solvent system is a lower phase of the multiple-phase solvent system.

22. The method of claim 1, wherein:
the multiple-phase solvent system is a first multiple phase solvent system comprising:
alkane in an amount of at least 10% and up to 14% v/v of the multiple-phase solvent system;
ethyl acetate in an amount of at least 36% and up to 40% v/v of the multiple-phase solvent;
methanol in an amount of at least 10% and up to 14% v/v of the multiple-phase solvent system; and
water in an amount of at least 36% and up to 40% v/v of the multiple-phase solvent;
the first phase is an upper phase of the first multiple phase solvent system;
the second phase is a lower phase of the first multiple phase solvent system;
the separating and collecting each comprises flowing a separation aliquot of the first phase of the multiple-phase solvent system through the one or more centrifugal partition chromatography columns in an ascending mode and flowing a separation aliquot of the second phase of the multiple-phase solvent system through the one or more centrifugal partition chromatography columns in a descending mode;
the first component comprises any one or more, any two or more, any three or more, any four or more, any five or more, any six or more, any seven or more, any eight or more, any nine or more, or each of para-hydroxybenzaldehyde, para-hydroxybenzoic acid, vanillin, vanillic acid, acetovanillone, 5-formyl-2-hydroxy-3-methoxybenzoic acid, 5-carboxyvanillic acid, syringaldehyde, syringic acid, and acetosyringone; and
the second component comprises an aromatic oligomer.

23. The method of claim 1, wherein:
the multiple-phase solvent system is a second multiple phase solvent system comprising:
alkane in an amount of at least 17% and up to 23% v/v of the multiple-phase solvent system;
ethyl acetate in an amount of at least 27% and up to 33% v/v of the multiple-phase solvent;
methanol in an amount of at least 17% and up to 23% v/v of the multiple-phase solvent system; and
water in an amount of at least 27% and up to 33% v/v of the multiple-phase solvent;
the first phase is an upper phase of the first multiple phase solvent system;
the second phase is a lower phase of the first multiple phase solvent system;
the separating comprises flowing a separation aliquot of the first phase of the multiple-phase solvent system through the one or more centrifugal partition chromatography columns in an ascending mode and flowing a separation aliquot of the second phase of the multiple-phase solvent system through the one or more centrifugal partition chromatography columns in a descending mode;
the collecting the first eluate comprises flowing a separation aliquot of the first phase of the multiple-phase solvent system through the one or more centrifugal partition chromatography columns in a descending mode;
the first component comprises any one or more, any two or more, any three or more, any four or more, any five or more, any six or more, any seven or more, or each of para-hydroxybenzaldehyde, para-hydroxybenzoic acid, vanillin, vanillic acid, acetovanillone, 5-formyl-2-hydroxy-3-methoxybenzoic acid, syringaldehyde, and acetosyringone; and
the collecting the second eluate comprises flowing a separation aliquot of the first phase of the multiple-phase solvent system through the one or more centrifugal partition chromatography columns in an ascending mode and flowing a separation aliquot of the second phase of the multiple-phase solvent system through the one or more centrifugal partition chromatography columns in a descending mode; and
the second component comprises an aromatic oligomer.
